(19) United States
(12) Patent Application Publication
(10) Pub. No.: US 2008/0294727 A1
(43) Pub. Date: Nov. 27, 2008

(54) Unsubscribing From Notification Of Future Messages In A Thread

(76) Inventors: Paul B. Moody, Hyde Park, VT (US); Jodi L. Coppinger, Merrimack, NH (US); Niklas Heidloff, Salzkotten (DE); Michael R. O'Brien, Westford, MA (US)

Correspondence Address: HOFFMAN WARNICK LLC, 75 STATE STREET, 14TH FLOOR, ALBANY, NY, 12207, US

(21) Appl. No.: 11/751,962

(22) Filed: May 22, 2007

(51) Int. Cl. G06F 15/16

(52) U.S. Cl. 709/206

(57) ABSTRACT

The present invention relates to unsubscribing from notification of future messages in an existing message thread. A method for controlling user notification of future electronic mail (email) messages in accordance with an embodiment of the present invention includes: receiving an email message addressed to a user; determining if the email message belongs to an existing message thread; and in the case the email message belongs to an existing message thread, presenting the user with a selection of a plurality of options for controlling notification of future emails addressed to the user and belonging to the existing message thread.

### CROSS-REFERENCE TO RELATED APPLICATIONS

This application is related to commonly owned co-pending U.S. patent application entitled “System and Method for Searching and Retrieving Related Messages,” Ser. No. 10/745,588, filed on Dec. 29, 2003, now U.S. Patent Application Publication US 2005/0144157, published Jun. 30, 2005, which is herewith incorporated by reference in its entirety.

### FIELD OF THE INVENTION

The present invention relates to electronic mail (email), and more specifically relates to unsubscribing from notification of future messages in an existing message thread.

### BACKGROUND OF THE INVENTION

Email users often have to deal with an excessive number of emails in their in-boxes. Some of these emails may be associated with an email message thread comprising a group of emails all related to a single topic. This problem is often exacerbated by the bad habit many email users have of copying too many people in a message thread (e.g., using the “Reply-to-All” command). Unfortunately, in current messaging systems, a user has no way to indicate that they are not interested in receiving future messages in a message thread, or that only selected future message types might cause the user to become interested in the message thread again. In short, there is no way for a user to unsubscribe from a message thread when the user's email address is specifically entered in the future messages.

### SUMMARY OF THE INVENTION

The present invention relates to unsubscribing from notification of future messages in an existing message thread. In accordance with the present invention, a user can specify under what circumstances the user is to be notified of new messages in an existing message thread. Options for notification settings may include, for example, always notify, never notify, and notify if condition X is met. Unsubscribed message threads are listed in a unsubscribed folder, which provides a way for a user to look into an existing message thread without changing the notification settings, or to change the notification settings as well as other message and message thread operations (e.g., delete, forward, print, etc.). Notification settings can be indicated in a thread object associated with an existing message thread. To this extent, the thread object defines not just the collection of messages currently in the existing message thread, but also indicates whether the user would like to be notified about future messages in the existing message thread, or only about selected future messages in the existing message thread.

A first aspect of the present invention is directed to a method for controlling user notification of future electronic mail (email) messages, comprising: receiving an email message addressed to a user; determining if the email message belongs to an existing message thread; and in the case the email message belongs to an existing message thread, presenting the user with a selection of a plurality of options for controlling notification of future emails addressed to the user and belonging to the existing message thread.

A second aspect of the present invention is directed to a system for controlling user notification of future email messages, comprising: an email system for receiving an email message addressed to a user; a message threading service for determining if the email message belongs to an existing message thread; and a system for presenting the user with a selection of a plurality of options for controlling notification of future emails addressed to the user and belonging to the existing message thread, in the case the email message belongs to an existing message thread.

A third aspect of the present invention is directed to a program product stored on a computer readable medium, which when executed, control user notification of future email messages, the computer readable medium comprising program code for: receiving an email message addressed to a user; determining if the email message belongs to an existing message thread; and in the case the email message belongs to an existing message thread, presenting the user with a selection of a plurality of options for controlling notification of future emails addressed to the user and belonging to the existing message thread.

The illustrative aspects of the present invention are designed to solve the problems herein described and other problems not discussed.

### BRIEF DESCRIPTION OF THE DRAWINGS

These and other features of this invention will be more readily understood from the following detailed description of the various aspects of the invention taken in conjunction with the accompanying drawings.

FIG. 1 is an illustrative hybrid system/process diagram in accordance with an embodiment of the present invention.

FIG. 2 depicts an illustrative email message that forms a portion of a message thread in accordance with an embodiment of the present invention.

FIG. 3 depicts a flow diagram of an illustrative process carried out upon receipt of a new email message in accordance with an embodiment of the present invention.

FIG. 4 depicts an illustrative computer system for implementing embodiment(s) of the present invention.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

As detailed above, the present invention relates to unsubscribing from notification of future messages in an existing message thread. In accordance with the present invention, a user can specify under what circumstances the user is to be notified of new messages in an existing message thread. Options for notification settings may include, for example, always notify, never notify, and notify if condition X is met. Unsubscribed message threads are listed in a unsubscribed folder, which provides a way for a user to look into an existing message thread without changing the notification settings, or to change the notification settings as well as other message and message thread operations (e.g., delete, forward, print, etc.). Notification settings can be indicated in a thread object associated with an existing message thread. To this extent, the thread object defines not just the collection of messages currently in the existing message thread, but also indicates whether the user would like to be notified about future messages in the existing message thread, or only about selected future messages in the existing message thread.

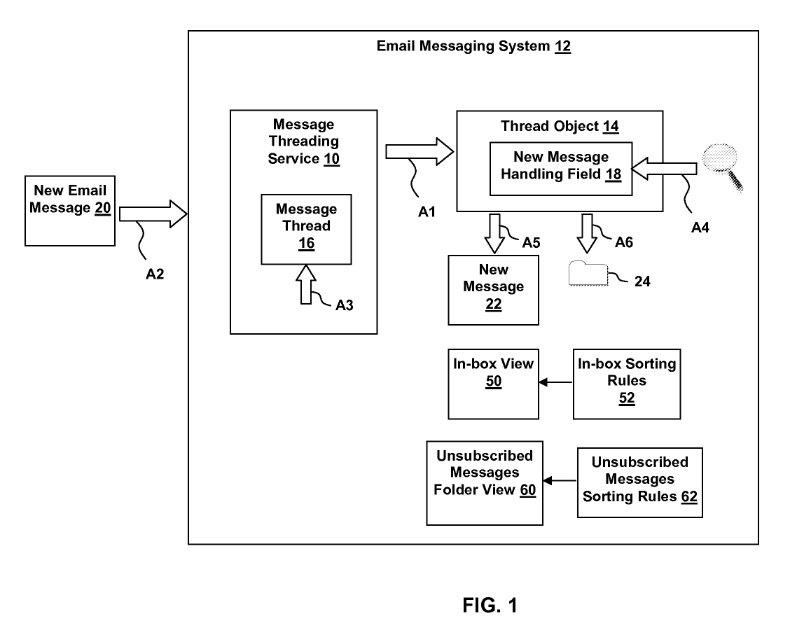

In accordance with an embodiment of the present invention, as depicted in FIG. 1, a message threading service 10 of an email messaging system 12 creates (A1) a thread object 14 for each unique message thread 16. Unlike known thread objects, the thread object 14 additionally includes a data field 18 for new message handling. When a new email message 20 addressed to a user and associated with an existing message thread 16 is received (A2) by the email messaging system 12, the message 20 is threaded (A3) into the message thread 16 and the new message handling field 18 in the thread object 14 is inspected (A4) to determine if the new message 20 should be processed (A5) as a new message 22 or sorted (A6) into an unsubscribed messages folder 24.

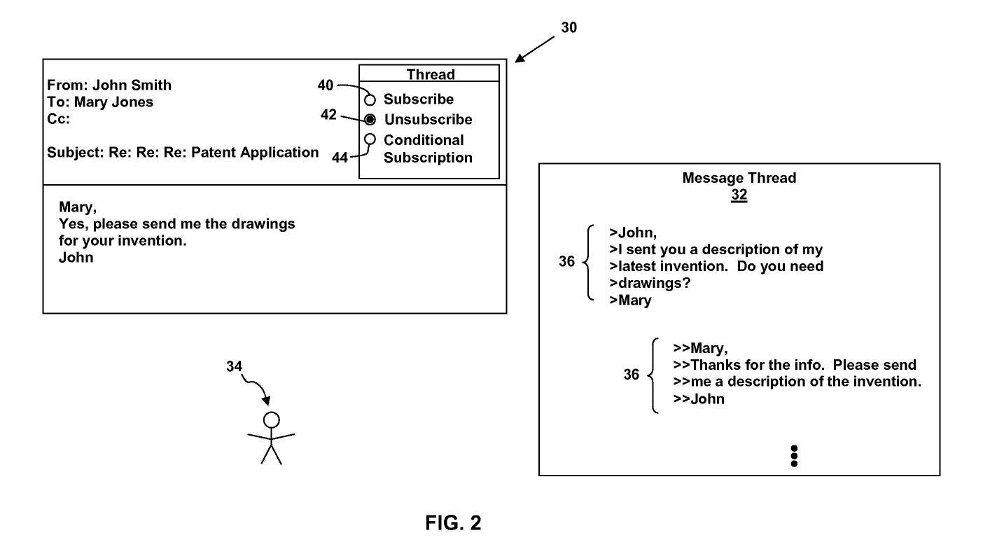

A user can selectively actuate a command to subscribe, unsubscribe, or conditionally subscribe to a new email message in an existing message thread. The selection made by the user is stored as a value in the new message handling field 18 in the thread object 14 associated with the existing message thread. An illustrative email message 30 that forms a portion of an existing message thread 32 is depicted in FIG. 2. The message 30 can be displayed to a user 34 in a list, in preview mode, using a document viewer, and/or using any now known or later developed technique.

The content 36 of several earlier email messages that belong to the existing message thread 32 is also displayed in FIG. 2. It should be noted that the email message 30, existing message thread 32, etc. can be displayed/presented to a user 34 in many different ways and that the example shown in FIG. 2 is not intended to be limiting in any way.

As shown in FIG. 2, the user 34 is presented with a choice of notification options for new messages in the existing message thread 32. The choice of notification options is presented to the user 34 after a new message (e.g., message 30) addressed to the user 34 and belonging to the existing message thread 32 has been displayed to the user 34. The options include, but are not limited to:
A) Subscribe (e.g., always notify the user of new messages in an existing message thread (e.g., “You have a new message”));
B) Unsubscribe (e.g., never notify the user of new messages in an existing message thread); and
C) Conditional Subscription (e.g., only notify the user of new messages in an existing message thread if new message attributes meet a predetermined condition X (or multiple predetermined conditions X, Y, Z, etc.)). The predetermined condition can comprise, for instance, from a particular person (boss, domain expert, friend), contains special keywords (“severity 3”, “for Legal dept”, etc.) or property (has attachment, marked ‘urgent’, etc.), and/or the like. Many other predetermined conditions are possible.

In FIG. 2, the choice of notification options for new messages in the existing message thread 32 is presented to the user 34 (i.e., “Mary Jones”) in the form of radio buttons. In particular, the radio buttons comprise: a subscribe radio button 40, an unsubscribe radio button 42, and a conditional subscription radio button 44. In this case, the user 34 can select one of these options via the corresponding radio button. When the conditional subscription radio button 44 is selected, the user 34 is provided with a drop-down menu, dialog window, and/or the like, which can be used to set the condition(s) that need to be met in order for the user 34 to be notified of new messages received for the existing message thread 32. Other selection mechanisms for allowing a user to select a notification option (and notification conditions) can include, for example, command buttons, keyboard commands/shortcuts, menu selections, mouse gestures, voice commands, predefined rules, etc. Indeed, any now known or later developed selection mechanisms/techniques can be used in the practice of the present invention to select a notification option (and notification conditions) for new messages in the existing message thread 32. Regardless of how the selection is implemented, a value corresponding to the selection made by the user is stored in the new message handling field 18 in the thread object 14.

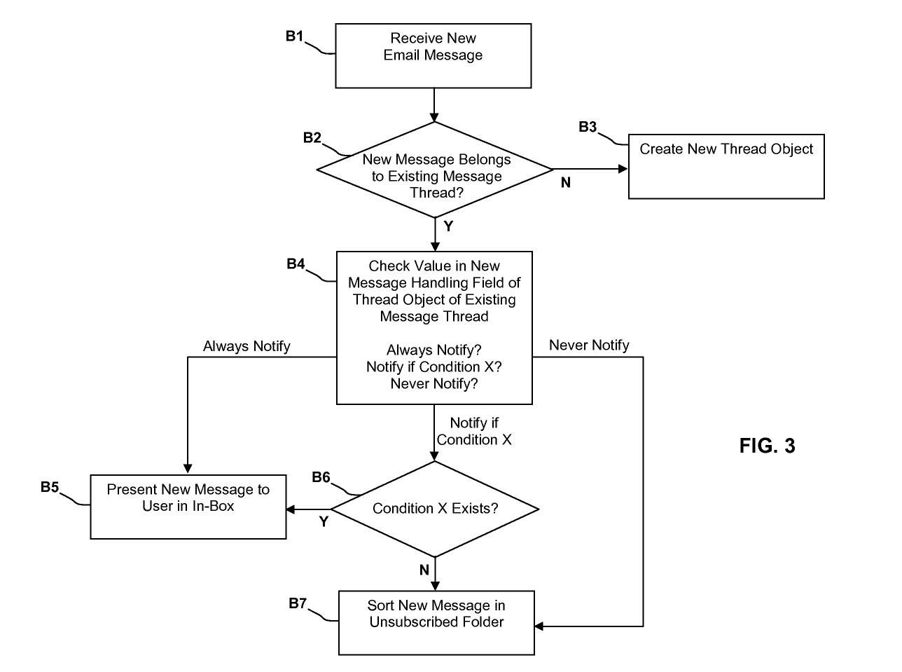

Referring now to FIG. 3 in conjunction with FIG. 1, there is depicted a flow diagram of an illustrative process carried out upon receipt of a new email message 20 in accordance with an embodiment of the present invention. This process is carried out after a user has already selected a notification option for new messages in an existing message thread (e.g., message thread 16).

In B1, a new email message 20 addressed to a user is received at the email message system 12. In B2, the new message 20 is examined (i.e., threaded) by the message threading service 10 to determine if the new message 20 belongs to an existing message thread (e.g., message thread 16) or is a new message starting a new message thread.

If it is determined in B2 that the new message 20 is a new message starting a new message thread (No, B2), the message threading service 10 creates a new thread object 14 for the new message thread in B3. If it is determined in B2 that the new message 20 belongs to an existing message thread (e.g., message thread 16) (Yes, B2), the message threading system 10 checks the value in the new message handling field 18 of the thread object 14 corresponding to the existing message thread in B4. The data is analyzed as follows:
1. If the value is determined to be “always notify,” flow passes to B5, where the email messaging system 12 treats the new message 20 as a new message and presents the new message 20 to the user in their in-box view 50 based on the user's in-box sorting rules 52.
2. If the value is “notify if condition X,” flow passes to B6, where the email messaging system 12 checks for the condition X.
   a. If condition X exists (Yes, B6), the new message 20 is presented to the user in their in-box view 50 in B5 based on the user's in-box sorting rules 52.
   b. If condition X does not exist, the new message 20 is sorted into the user's unsubscribed folder 24 in B7 and not processed by the in-box sorting rules 52.
3. If the value is “never notify,” the new message 20 is sorted into the user's unsubscribed folder 24 in B7 and not processed by the in-box sorting rules 52.

A user can access and view the message threads contained in the unsubscribed messages folder 24 in an unsubscribed messages folder view 60, based on the user's unsubscribed messages sorting rules 62. A message thread can be selected and commands for viewing and editing are available. The commands can include, but are not limited to:
A) View the messages in a message thread. This lists all the messages in the message thread, which can be sorted by date/time, sender, etc.
B) Delete messages from a message thread. This deletes the messages in the message thread, but keeps the thread object associated with the message thread and its current new message handling settings.
C) Delete an entire message thread. This deletes the messages in the message thread and the thread object associated with the message thread. To this extent, a future message from this thread will start a new message thread. Alternatively, the thread object can be maintained, but the messages deleted, causing new messages to be threaded to the deleted thread, essentially restarting the old thread. Further, if there is soft delete and the messages have not yet be actually deleted, the thread and its messages could be restored (undeleted).
D) Re-subscribe to a message thread. This sets the new message handling value of the thread object of the message thread to “always notify.”
E) Edit conditional subscription for a message thread. This presents the user with options for specifying condition X that will cause new message notification for future messages in the message thread.

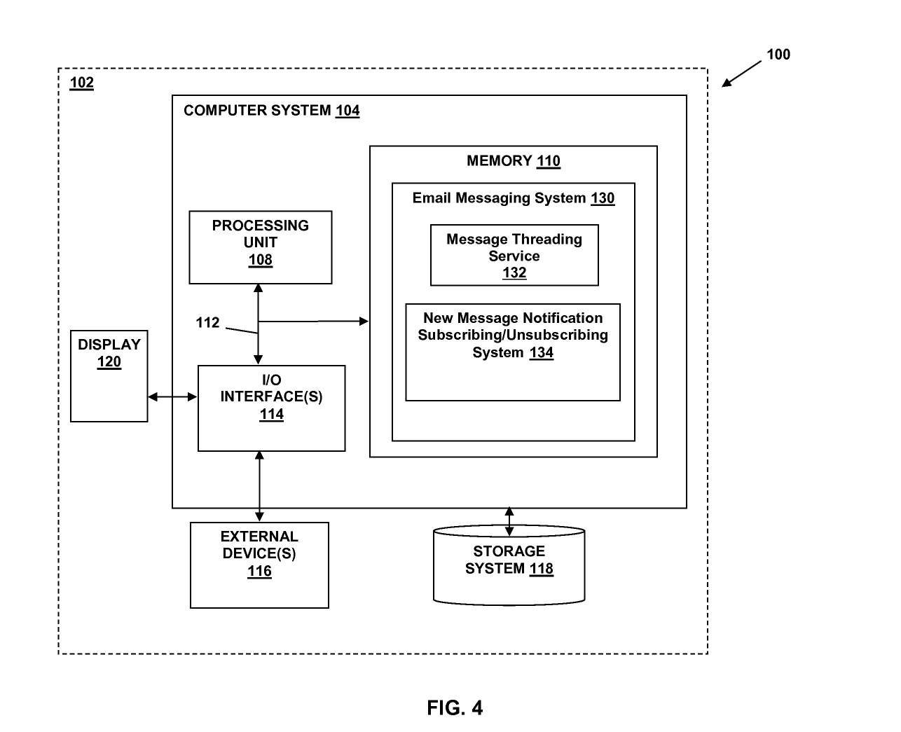

FIG. 4 depicts an illustrative system 100 for unsubscribing from notification of future messages in a message thread, in accordance with any/all embodiments of the present invention. The system 100 includes a computer infrastructure 102 that can perform the various processes described herein. The computer infrastructure 102 is shown including a computer system 104.

The computer system 104 is shown as including a processing unit 108, a memory 110, at least one input/output (I/O) interface 114, and a bus 112. Further, the computer system 104 is shown in communication with at least one external device 116 and a storage system 118. In general, the processing unit 108 executes computer program code, such as an email messaging system 130, that is stored in memory 110 and/or storage system 118. While executing computer program code, the processing unit 108 can read and/or write data from/to the memory 110, storage system 118, and/or I/O interface(s) 114. Bus 112 provides a communication link between each of the components in the computer system 104. The external device(s) 116 can comprise any device (e.g., display 120) that enables a user to interact with the computer system 104 or any device that enables the computer system 104 to communicate with one or more other computer systems.

The email messaging system 130 is configured to implement any/all embodiments of the of the present invention, as detailed above. For example, the email messaging system 130 can comprise a message threading service 132 and a new message notification subscribing/unsubscribing system 134. The new message notification subscribing/unsubscribing system 134 is configured to inspect the new message handling field of a thread object of an existing message thread to determine whether to notify a user of a new message in the existing message thread.

The computer system 104 can comprise any general purpose computing article of manufacture capable of executing computer program code installed by a user (e.g., a personal computer, server, handheld device, etc.). However, it is understood that the computer system 104 is only representative of various possible computer systems that may perform the various processes of the invention. To this extent, in other embodiments, the computer system 104 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively.

Similarly, the computer infrastructure 102 is only illustrative of various types of computer infrastructures that can be used to implement the present invention. For example, in an embodiment, the computer infrastructure 102 comprises two or more computer systems (e.g., a server cluster) that communicate over any type of wired and/or wireless communications link, such as a network, a shared memory, or the like, to perform the various processes of the invention. When the communications link comprises a network, the network can comprise any combination of one or more types of networks (e.g., the Internet, a wide area network, a local area network, a virtual private network, etc.). Regardless, communications between the computer systems may utilize any combination of various types of transmission techniques.

It is understood that some of the various systems shown in FIG. 4 can be implemented independently, combined, and/or stored in memory for one or more separate computer systems that communicate over a network. Further, it is understood that some of the systems and/or functionality may not be implemented, or additional systems and/or functionality may be included as part of the system 100.

It is understood that the invention further provides various alternative embodiments. For example, in an embodiment, the invention provides a computer-readable medium that includes computer program code to enable a computer infrastructure to carry out and/or implement the various processes of the present invention. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computer system, such as the memory 110 and/or storage system 118 (e.g., a fixed disk, a read-only memory, a random access memory, a cache memory, etc.), and/or as a data signal traveling over a network (e.g., during a wired/wireless electronic distribution of the program code).

In another embodiment, the invention provides a business method that performs the processes of the invention on a subscription, advertising, and/or fee basis. A service provider can create, maintain, support, etc., a computer infrastructure, such as the computer infrastructure 102, that performs the processes of the invention for one or more customers. In return, the service provider can receive payment from the customer(s) under a subscription and/or fee agreement and/or the service provider can receive payment from the sale of advertising space to one or more third parties.

In still another embodiment, a computer infrastructure, such as the computer infrastructure 102, can be obtained (e.g., created, maintained, having made available to, etc.) and one or more systems for performing the processes of the invention can be obtained (e.g., created, purchased, used, modified, etc.) and deployed to the computer infrastructure. To this extent, the deployment of each system can comprise one or more of (1) installing program code on a computer system, such as the computer system 104, from a computer-readable medium; (2) adding one or more computer systems to the computer infrastructure; and (3) incorporating and/or modifying one or more existing systems of the computer infrastructure, to enable the computer infrastructure to perform the processes of the invention.

As used herein, it is understood that the terms “program code” and “computer program code” are synonymous and mean any expression, in any language, code or notation, of a set of instructions intended to cause a computer system having an information processing capability to perform a particular function either directly or after either or both of the following: (a) conversion to another language, code or notation; and (b) reproduction in a different material form. The program code can be embodied as one or more types of program products, such as an application/software program, component software/a library of functions, an operating system, a basic I/O system/driver for a particular computing and/or I/O device, and the like.

The foregoing description of the preferred embodiments of this invention has been presented for purposes of illustration and description. It is not intended to be exhaustive or to limit the invention to the precise form disclosed, and obviously, many modifications and variations are possible.

What is claimed is:

1. A method for controlling user notification of future electronic mail (email) messages, comprising:
receiving an email message addressed to a user;
determining if the email message belongs to an existing message thread; and
in the case the email message belongs to an existing message thread, presenting the user with a selection of a plurality of options for controlling notification of future emails addressed to the user and belonging to the existing message thread.

2. The method of claim 1, wherein the plurality of options further comprises subscribe, unsubscribe, and conditionally subscribe to the notification of future emails addressed to the user and belonging to the existing message thread.

3. The method of claim 2, wherein upon selection of the subscribe option by the user, always notifying the user of future emails addressed to the user and belonging to the existing message thread.

4. The method of claim 2, wherein upon selection of the unsubscribe option by the user, never notifying the user of future emails addressed to the user and belonging to the existing message thread.

5. The method of claim 4, wherein upon selection of the unsubscribe option by the user, placing future emails addressed to the user and belonging to the existing message thread into an unsubscribed folder.

6. The method of claim 2, wherein upon selection of the conditionally subscribe option by the user, notifying the user of future emails addressed to the user and belonging to the existing message thread only if at least one predetermined condition is met.

7. The method of claim 1, further comprising:
storing a value indicating the option selected by the user in a new message handling field of a thread object corresponding to the existing message thread.

8. The method of claim 7, further comprising:
receiving a new email belonging to the existing message thread;
checking the value in the message handling field of the thread object corresponding to the existing message thread; and
selectively notifying the user of the new message based on the value in the message handling field of the thread object corresponding to the existing message thread.

9. A system for controlling user notification of future electronic mail (email) messages, comprising:
an email system for receiving an email message addressed to a user;
a message threading service for determining if the email message belongs to an existing message thread; and
a system for presenting the user with a selection of a plurality of options for controlling notification of future emails addressed to the user and belonging to the existing message thread, in the case the email message belongs to an existing message thread.

10. The system of claim 9, wherein the plurality of options further comprises subscribe, unsubscribe, and conditionally subscribe to the notification of future emails addressed to the user and belonging to the existing message thread.

11. The system of claim 10, further comprising a notification system for notifying a user of a new email, wherein upon selection of the subscribe option by the user, the notification system always notifies the user of future emails addressed to the user and belonging to the existing message thread.

12. The system of claim 10, further comprising a notification system for notifying a user of a new email, wherein upon selection of the unsubscribe option by the user, the notification system stops notifying the user of future emails addressed to the user and belonging to the existing message thread.

13. The system of claim 12, further comprising an unsubscribed folder, wherein upon selection of the unsubscribe option by the user, future emails addressed to the user and belonging to the existing message thread are placed into the unsubscribed folder.

14. The system of claim 10, further comprising a notification system for notifying a user of a new email, wherein upon selection of the conditionally subscribe option by the user, the notification system notifies the user of future emails addressed to the user and belonging to the existing message thread only if at least one predetermined condition is met.

15. The system of claim 9, further comprising:
a system for storing a value indicating the option selected by the user in a new message handling field of a thread object corresponding to the existing message thread.

16. The method of claim 15, wherein, upon receipt of a new email by the email system and a determination by the message threading service that the new email belongs to the existing message thread, the system for presenting checks the value in the message handling field of the thread object corresponding to the existing message thread, and selectively notifies the user of the new message based on the value in the message handling field of the thread object corresponding to the existing message thread.

17. A program product stored on a computer readable medium, which when executed, controls user notification of future electronic mail (email) messages, the computer readable medium comprising program code for:
receiving an email message addressed to a user;
determining if the email message belongs to an existing message thread; and
presenting the user with a selection of a plurality of options for controlling notification of future emails addressed to the user and belonging to the existing message thread, in the case the email message belongs to an existing message thread.

18. A method, comprising:
receiving a new email belonging to an existing message thread;
checking a value in a message handling field of the thread object corresponding to the existing message thread; and
selectively notifying a user of the new message based on the value in the message handling field of the thread object corresponding to the existing message thread.
